(19) United States
(12) Patent Application Publication
(10) Pub. No.: US 2014/0081528 A1
(43) Pub. Date: Mar. 20, 2014

(54) Method of Controlling a Vehicle Drive Train with a Hydrodynamic Retarder

(71) Applicant: Voith Patent GmbH, Heidenheim (DE)

(72) Inventors: Achim Menne, Crailsheim (DE); Tilman Huth, Satteldorf (DE); Dieter Laukemann, Crailsheim (DE); Martin Becke, Ulm (DE); Werner Adams, Crailsheim (DE); Werner Klement, Heidenheim (DE)

(73) Assignee: Voith Patent GmbH, Heidenheim (DE)

(21) Appl. No.: 13/979,353

(22) PCT Filed: Jan. 31, 2013
(86) PCT No.: PCT/EP2013/051925

§ 371 Date: Nov. 7, 2013

(30) Foreign Application Priority Data
Mar. 12, 2012 (DE) 102012004687.1

(51) Int. Cl. B60W 10/196

(52) U.S. Cl. CPC B60W 10/196
USPC 701/48

(57) ABSTRACT

The invention concerns a method for controlling a vehicle drive train with a hydrodynamic retarder which can be engaged and disengaged mechanically via a coupling, whereas the retarder comprises a working chamber formed between two bladed wheels, which is filled with a working fluid for generating a braking torque after detecting a retarder switch-on signal and is emptied of the working medium after detecting a retarder switch-off signal to turn off the braking torque, and the retarder is driven in braking mode by means of a drive shaft via the closed coupling to constitute a hydrodynamic circuit of the working fluid in the working chamber.

The invention is characterised in that the speed of the vehicle and/or the rotational speed of the drive shaft is detected or calculated and the coupling is closed above a preset limit speed and/or above a preset limit rotation speed independent of the detection of a retarder switch-on signal to drive the retarder.

The present invention concerns a method of controlling a vehicle drive train with a hydrodynamic retarder which can be engaged and disengaged mechanically via a coupling, in detail according to the preamble of claim 1.

Hydrodynamic retarders have been used for many years as wear-free continuous brakes in motor vehicles on tracks as well as on the road, the latter in particular in lorries. Although such wear-free continuous brakes as regards safety when braking the vehicle and as regards minimal wear of the frictional service brakes have indisputably considerable advantages, the no-load losses in non-braking mode of the hydrodynamic retarder constitute a critical point. Said no-load losses could still be decreased by providing so-called ventilation plates or by providing a rotor (primary wheel) moving away from the stator (secondary wheel) in non-braking mode. The measures aforementioned are hence usually insufficient to bring the no-load losses down to practically zero.

A possibility to bring down to zero the no-load losses of such a hydrodynamic retarder consists in designing the hydrodynamic retarder by means of a separating clutch as able to be released from the drive train.

The European patent document EP 2 024 209 B1 suggest for shortening the reaction time of a hydrodynamic retarder connected to the drive train via a separating clutch to preventively close the separating clutch every time there is no traction of the motor vehicle and to engage the retarder in emptied condition.

The disclosure DE 199 27 397 A1 suggests a self-reinforcing friction coupling for engaging the hydrodynamic retarder, which enables to engage the hydrodynamic retarder also in filled condition.

The disclosure DE 10 2005 052 121 A1 suggests switching off a hydrodynamic retarder by emptying its working chamber and simultaneously releasing the stator, so that the latter may spin with the rotor.

The disclosure DE 10 2009 001 146 A1 suggests a coaxial arrangement of the rotor of the retarder and of the rotor of an electric motor which can be disconnected together from the drive train via a separating clutch, in particular a desynchronised separating clutch.

A shortcoming of the separating clutch consists in that it must be designed comparatively large, so to overcome high switching work and sliding speeds among others during synchronisation, which are necessary according to the operating mode of the vehicle drive train, to engage mechanically the rotor of the same after a retarder switch-on signal. To do, at least first of all the rotor of the hydrodynamic retarder, consequently those of both bladed wheels of the retarder forming together the working chamber, which is driven via the clutch must be brought to the same rotational speed as the associated drive shaft after which both coupling sections can usually be locked mechanically. If an additional gear ratio is provided between the clutch and the retarder, a synchronisation is nevertheless necessary in the coupling, even when the retarder rotates with another rotational speed as the coupling.

The object of the present invention is then to offer a method for controlling a vehicle drive train with a hydrodynamic retarder which can be engaged and disengaged mechanically via a coupling, which enables using a smaller and more cost-effective coupling.

The object of the invention is satisfied with a process exhibiting the features of claim 1. Advantageous and particularly appropriate embodiments of the invention are disclosed in the dependent claims.

According to the method of the invention the hydrodynamic retarder is engaged and disengaged mechanically via a coupling and then the working chamber of the retarder, which is formed between two bladed wheels of the retarder, in particular between a rotor and a stator or a rotor and a counter-rotor, is filled with a working fluid for generating a braking torque after detecting a retarder switch-on signal. Hence, the retarder is driven via a drive shaft and the closed coupling, generates a hydrodynamic circuit of the working medium in the working chamber and hence brakes the drive shaft hydrodynamically.

After detecting a retarder switch-off signal the working chamber of the hydrodynamic retarder is again emptied of the working medium so that there is essentially no more torque transmission between both blade wheels. Moreover, the coupling can be opened again to disengage the hydrodynamic retarder again mechanically from the drive train of the vehicle. To do so, an immediate mechanical disconnection is however not strictly necessary, but said disconnection cannot take place at all or with a time delay only in the presence of boundary conditions, if for instance the hydrodynamic retarder will probably be called upon in the near future.

In order now to be able to use a particularly small coupling for synchronising the hydrodynamic retarder and the coupling thereof with the drive shaft, the speed of the vehicle and/or the rotational speed of the drive shaft is detected or calculated according to the invention and the coupling is closed above a preset limit speed and/or above a preset limit rotation speed independent of the detection of a retarder switch-on signal to drive the retarder. It means that only when the speed of the vehicle is above the limit speed or when monitoring the rotational speed of the drive shaft, said rotational speed is above the limit rotational speed, immediate closing of the coupling is initiated or triggered, in order to prevent the matching synchronisation from becoming necessary in case of even higher vehicle speeds or rotational speeds of the drive shaft after detecting a retarder switch-on signal. The coupling can thus be designed with a maximum torque transferability in slipping or synchronising mode to be more accurate with a maximal admissible differential rotational speed between a driving member and output member of the coupling, which is below the torque or below the differential rotational speed, which would crop up if the initially mechanically disengaged hydrodynamic retarder at maximum speed of the vehicle or in the upper region of the possible speed of the vehicle or at maximum rotational speed of the drive shaft or in the upper region of the possible rotational speed of the drive shaft, would be engaged mechanically with the drive shaft by means of the coupling. Such torques or differential rotational speeds are according to the invention protected against any premature closing of the coupling.

An embodiment according to the invention provides an exception for the automatic closing of the coupling above the limit speed or above the limit rotation speed, namely when a fault of the hydrodynamic retarder has been detected and a future switch-on of the retarder is generally blocked until the fault has been corrected.

In an embodiment according to the invention, the coupling is closed only after detecting a retarder switch-on signal, with a speed of the vehicle below the limit speed and/or with a rotational speed of the drive shaft below the limit rotational speed. It can alternately also be provided to close the coupling just before detecting a retarder switch-on signal as a preventive measure, namely with at least one boundary condition which indicates imminent retarder switch-on signal or that a retarder switch-on signal is to be expected.

The closing of the coupling with a speed of the vehicle above the limit speed and/or with a rotational speed of the drive shaft above the limit rotation speed can for instance be actuated by an electronic control device. Such an electronic control device consequently has an input for the speed of the vehicle and/or the rotational speed of the drive shaft and/or for values from which the speed of the vehicle and/or the rotational speed of the drive shaft is calculated, and actuates the coupling according to these input variables. The electronic control device can for instance be provided in addition to a usual retarder control device or be integrated therein.

According to another embodiment of the invention, the coupling can be operated mechanically above the limit speed or above the limit rotation speed. To that end, a mechanical closing device can be provided, which is triggered by centrifugal forces or other forces related to the rotational speed or the speed and causes the coupling to close.

When engaging the retarder by means of the coupling with the drive shaft whereas such engaging operation includes an engaging operation without transmission ratio between the drive shaft and the rotor of the retarder as well as an engaging operation with such a transmission ratio, a driving member and an output member of the coupling advantageously see their rotational speeds synchronised initially and then the driving member and the output member are mechanically interlocked, in particular by a mechanical interlocking. Such a mechanical interlocking can for instance involve inserting the driving member and the output member into one another, in particular by moving them relatively to one another and meshing them with corresponding protrusions and recesses.

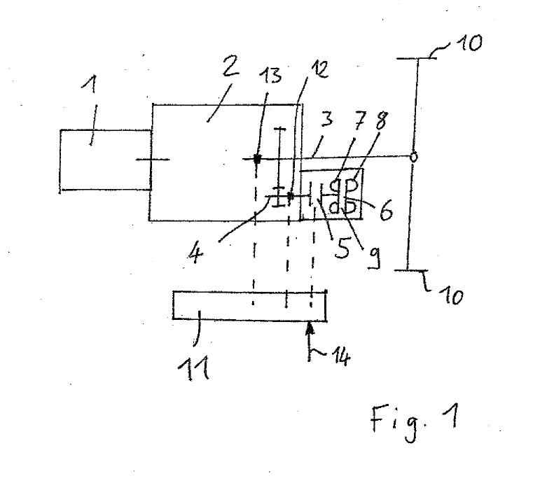

FIG. 1 represents an exemplary illustration of a vehicle drive train, with which the method according to the invention is employed.

On the secondary side of the vehicle transmission 2 which is driven by the drive motor 1, an auxiliary output shaft 4 is provided in a boost side leading to the transmission output shaft 3 and drives the hydrodynamic retarder 6, more precisely its rotor 7, via the coupling 5, to transfer the torque hydrodynamically from the rotor 7 to the stator 8 when the working chamber 9 of the hydrodynamic retarder is filled with working medium. The result is that the drive shaft 4 is braked down hydrodynamically and with it the transmission output shaft 3 and the wheels 10 of the motor vehicle.

A control device 11, in particular in the form of an electronic control device, controls the opening and closing of the coupling 5. According to an embodiment, the control device 11 also actuates the filling and emptying of the working chamber 9 of the hydrodynamic retarder 6 with working medium.

The control device 11 exhibits at least one input for a speed signal of the motor vehicle or a rotational speed signal of the drive shaft 4. It is also possible that the control device 11 calculates the speed of the motor vehicle or the rotational speed of the drive shaft 4 from other variables conveyed to it. FIG. 1 represents by way of example a rotational speed sensor 12 on the drive shaft 4 i.e. additionally or alternately a rotational speed sensor 13 on the transmission output shaft 3.

Moreover, the control device 11 can also include an input for a retarder switch-on signal and/or a retarder switch-off signal, here designated by 14 by way of example.

Every time the speed of the motor vehicle is above a preset limit speed and/or if the rotational speed of the drive shaft 4 is greater than a preset limit rotation speed, the control device 11 closes the coupling 5 and hence limits the switching work to be performed by the coupling 5 and the sliding speeds occurring in the coupling 5.

1-6. (canceled)

7. A method for controlling a vehicle drive train with a hydrodynamic retarder which can be engaged and disengaged mechanically via a coupling, whereas the retarder comprises a working chamber formed between two bladed wheels, which is filled with a working fluid for generating a braking torque after detecting a retarder switch-on signal and is emptied of the working medium after detecting a retarder switch-off signal to turn off the braking torque, and the retarder is driven in braking mode by means of a drive shaft via the closed coupling to constitute a hydrodynamic circuit of the working fluid in the working chamber, the method comprising:
detecting or calculating at least one of the speed of the vehicle and the rotational speed of the drive shaft; and
closing the coupling above at least one of a preset limit speed and a preset limit rotation speed independent of the detection of a retarder switch-on signal in order to drive the retarder.

8. The method according to claim 7, wherein with a speed of the vehicle above the limit speed and/or a rotational speed of the drive shaft above the limit rotation speed, the coupling always closes, in particular except after detecting a fault of the hydrodynamic retarder, at which any future switch-on of the hydrodynamic retarder is blocked until the fault has been corrected.

9. The method according to claim 7, wherein with a speed of the vehicle below the limit speed and/or a rotational speed of the drive shaft below the limit rotation speed, the coupling only closes after detecting a retarder switch-on signal or after detecting a boundary condition, signaling the output of a retarder switch-on signal to be expected.

10. The method according to claim 8, wherein with a speed of the vehicle below the limit speed and/or a rotational speed of the drive shaft below the limit rotation speed, the coupling only closes after detecting a retarder switch-on signal or after detecting a boundary condition, signaling the output of a retarder switch-on signal to be expected.

11. The method according to claim 7, wherein the closing of the coupling is actuated by an electronic control device with a speed of the vehicle above the limit speed and/or a rotational speed of the drive shaft above the limit rotation speed.

12. The method according to claim 8, wherein the closing of the coupling is actuated by an electronic control device with a speed of the vehicle above the limit speed and/or a rotational speed of the drive shaft above the limit rotation speed.

13. The method according to claim 9, wherein the closing of the coupling is actuated by an electronic control device with a speed of the vehicle above the limit speed and/or a rotational speed of the drive shaft above the limit rotation speed.

14. The method according to claim 10, wherein the closing of the coupling is actuated by an electronic control device with a speed of the vehicle above the limit speed and/or a rotational speed of the drive shaft above the limit rotation speed.

15. The method according to claim 7, wherein the closing of the coupling is actuated by a mechanical closing device with a speed of the vehicle above the limit speed and/or a rotational speed of the drive shaft above the limit rotation speed, which is triggered by centrifugal forces or other forces related to the rotational speed or the speed.

16. The method according to claim 8, wherein the closing of the coupling is actuated by a mechanical closing device with a speed of the vehicle above the limit speed and/or a rotational speed of the drive shaft above the limit rotation speed, which is triggered by centrifugal forces or other forces related to the rotational speed or the speed.

17. The method according to claim 9, wherein the closing of the coupling is actuated by a mechanical closing device with a speed of the vehicle above the limit speed and/or a rotational speed of the drive shaft above the limit rotation speed, which is triggered by centrifugal forces or other forces related to the rotational speed or the speed.

18. The method according to claim 10, wherein the closing of the coupling is actuated by a mechanical closing device with a speed of the vehicle above the limit speed and/or a rotational speed of the drive shaft above the limit rotation speed, which is triggered by centrifugal forces or other forces related to the rotational speed or the speed.

19. The method according to claim 7, wherein when coupling the retarder by means of the coupling to the drive shaft, the rotational speeds of a driving member and an output member of the coupling are synchronised and these members are then mechanically interlocked, in particular through a mechanical interlocking.

20. The method according to claim 8, wherein when coupling the retarder by means of the coupling to the drive shaft, the rotational speeds of a driving member and an output member of the coupling are synchronised and these members are then mechanically interlocked, in particular through a mechanical interlocking.

21. The method according to claim 9, wherein when coupling the retarder by means of the coupling to the drive shaft, the rotational speeds of a driving member and an output member of the coupling are synchronised and these members are then mechanically interlocked, in particular through a mechanical interlocking.

22. The method according to claim 10, wherein when coupling the retarder by means of the coupling to the drive shaft, the rotational speeds of a driving member and an output member of the coupling are synchronised and these members are then mechanically interlocked, in particular through a mechanical interlocking.

23. The method according to claim 11, wherein when coupling the retarder by means of the coupling to the drive shaft, the rotational speeds of a driving member and an output member of the coupling are synchronised and these members are then mechanically interlocked, in particular through a mechanical interlocking.

24. The method according to claim 12, wherein when coupling the retarder by means of the coupling to the drive shaft, the rotational speeds of a driving member and an output member of the coupling are synchronised and these members are then mechanically interlocked, in particular through a mechanical interlocking.

25. The method according to claim 13, wherein when coupling the retarder by means of the coupling to the drive shaft, the rotational speeds of a driving member and an output member of the coupling are synchronised and these members are then mechanically interlocked, in particular through a mechanical interlocking.

26. The method according to claim 14, wherein when coupling the retarder by means of the coupling to the drive shaft, the rotational speeds of a driving member and an output member of the coupling are synchronised and these members are then mechanically interlocked, in particular through a mechanical interlocking.
